(19) United States
(12) Patent Application Publication
(10) Pub. No.: US 2026/0319690 A1
(43) Pub. Date: Oct. 15, 2026

(54) ELECTRONIC DEVICE AND DATA MANAGEMENT METHOD USING SAME

(71) Applicant: SAMSUNG ELECTRONICS CO., LTD., Suwon-si (KR)

(72) Inventors: Huijin PARK, Suwon-si (KR); Youngwoo KIM, Suwon-si (KR); Jeeho YOON, Suwon-si (KR); Bumwoo LEE, Suwon-si (KR); Jungseung LEE, Suwon-si (KR)

(21) Appl. No.: 19/465,871

(22) Filed: Jan. 30, 2026

Related U.S. Application Data
(63) Continuation of application No. PCT/KR2024/009271, filed on Jul. 2, 2024.

(30) Foreign Application Priority Data
Aug. 4, 2023 (KR) 10-2023-0102469

(51) Int. Cl. G06F 3/06

(52) U.S. Cl. CPC G06F 3/0655; G06F 3/0608; G06F 3/0676; G06F 3/0679

(57) ABSTRACT

An electronic device for reading a compressed file may include: a memory storing at least one instruction; and at least one processor. comprising processing circuitry, individually and/or collectively, configured to execute the at least one instruction and to cause the electronic device to: register at least one file system, use virtual memory to read compressed data included in the at least one file system based on a read request occurring, and release the at least one file system. Based on the at least one file system being registered, the virtual memory may be allocated an address space and used to decompress the compressed data based on the read request. Based on the at least one file system being released, the address space may be released.

### CROSS-REFERENCE TO RELATED APPLICATIONS

This application is a continuation of International Application No. PCT/KR2024/009271 designating the United States, filed on July 2, 2024, in the Korean Intellectual Property Receiving Office and claiming priority to Korean Patent Application No. 10-2023-0102469, filed on August 4, 2023, in the Korean Ministry of Intellectual Property, the disclosures of each of which are incorporated by reference herein in their entireties.

### BACKGROUND

### FIELD

The disclosure relates to an electronic device for reading compressed data and a data management method using the same.

### DESCRIPTION OF RELATED ART

With the development of digital technology, various types of electronic devices such as smart TVs, smartphones, tablet PCs, electronic organizers, personal digital assistants (PDAs), or wearable devices are being used. An electronic device may include at least one hardware component for storing various types of data.

An electronic device may include storage such as a hard disk drive (HDD), solid state disk (SSD), or flash memory to store large-volume data required for performing various functions.

An electronic device may use virtual memory management techniques to efficiently store and manage data. For example, a virtual memory management technique is a method for managing data by mapping a main memory (e.g., dynamic random access memory (DRAM)) and storage (e.g., non-volatile memory), and may include a method for loading from data stored in the storage to the main memory at least some data required by a processor for processing.

In case of using the virtual memory management technique, overhead may occur because the address space of virtual memory should be repeatedly allocated and released during the data reading process. In case that such overhead continuously occurs, the performance of the electronic device may be degraded.

### SUMMARY

Embodiments of the disclosure may provide an electronic device that allocates an address space of virtual memory in case of registering a file system, releases the address space of virtual memory in case of releasing the file system, and reuses the address space of virtual memory while reading data based on a read request, and a data management method using the same.

According to an example embodiment of the disclosure, an electronic device for reading a compressed file may include: memory storing at least one instruction, and at least one processor, comprising processing circuitry, individually and/or collectively, configured to execute the at least one instruction, and to cause the electronic device to: register at least one file system, read compressed data included in the at least one file system using virtual memory according to an occurrence of a read request, and release the at least one file system. The virtual memory may have an address space allocated based on the at least one file system being registered, be used for decompression of the compressed data based on the read request, and have the address space released in case that the at least one file system is released.

8 In an embodiment, the virtual memory may be configured to reuse the address space for decompression of new compressed data by being memory-mapped from new physical memory based on a new read request occurring after being used for decompression of the compressed data based on the read request.

In an embodiment, at least one processor, individually and/or collectively, may be configured to cause the electronic device to: recognize the at least one file system at a first time point, initialize the at least one file system, allocate the address space of the virtual memory, and register the at least one file system in a main system.

In an embodiment, the first time point may be at least one of a time point at which the main system is booted and a time point at which a disk including the at least one file system is mounted.

In an embodiment, at least one processor, individually and/or collectively, may be configured to cause the electronic device to: terminate the at least one file system at a second time point, release the address space of the virtual memory, clean up the virtual memory, and remove the at least one file system from a main system.

In an embodiment, the second time point may be at least one of a time point at which a process of the main system is terminated and a time point at which a disk including the at least one file system is unmounted.

In an embodiment, at least one processor, individually and/or collectively, may be configured to cause the electronic device to: allocate a first memory space of first physical memory storing the compressed data, allocate a second memory space of second physical memory storing decompressed data, load the compressed data from a disk including the at least one file system, map the first physical memory to the address space of the virtual memory, and generate the decompressed data by decompressing the compressed data from the address space of the virtual memory.

In an embodiment, at least one processor, individually and/or collectively, may be configured to cause the electronic device to: store the decompressed data in the second memory space of the second physical memory, unmap the virtual memory to which the first physical memory is mapped, release the first memory space of the first physical memory, and read the decompressed data from the second memory space of the second physical memory.

In an embodiment, at least one processor, individually and/or collectively, may be configured to cause the electronic device to: receive a new read request after reading the decompressed data, map a new physical memory to the address space of the virtual memory, and decompress new compressed data included in mapping data mapped to the address space of the virtual memory.

In an embodiment, at least one processor, individually and/or collectively, may be configured to cause the electronic device to: identify a read request termination after reading the decompressed data, terminate the at least one file system, and release the address space of the virtual memory.

According to an example embodiment of the disclosure, a method for managing data using an electronic device may include: registering, by the electronic device, at least one file system, reading, by the electronic device, compressed data included in the at least one file system using virtual memory according to an occurrence of a read request, and releasing, by the electronic device, the at least one file system. The virtual memory may have an address space allocated in case that the electronic device registers the at least one file system, be used for decompression of the compressed data based on the read request, and have the address space released based on the electronic device releasing the at least one file system.

In an embodiment, the virtual memory may reuse the address space for decompression of new compressed data by being memory-mapped from new physical memory based on a new read request occurring after being used for decompression of the compressed data based on the read request.

In an embodiment, the registering the at least one file system may include: recognizing the at least one file system at a first time point, initializing the at least one file system, allocating the address space of the virtual memory, and registering the at least one file system in a main system.

In an embodiment, the first time point may be at least one of a time point at which the main system is booted and a time point at which a disk including the at least one file system is mounted.

In an embodiment, the releasing the at least one file system may include: terminating the at least one file system at a second time point, releasing the address space of the virtual memory, cleaning up the virtual memory, and removing the at least one file system from a main system.

In an embodiment, the second time point may be at least one of a time point at which a process of the main system is terminated and a time point at which a disk including the at least one file system is unmounted.

In an embodiment, the reading the compressed data included in the at least one file system using the virtual memory may include: allocating a first memory space of first physical memory storing the compressed data, allocating a second memory space of second physical memory storing decompressed data, loading the compressed data from a disk including the at least one file system, mapping the first physical memory to the address space of the virtual memory, and generating the decompressed data by decompressing the compressed data from the address space of the virtual memory.

In an embodiment, the reading the compressed data included in the at least one file system using the virtual memory may include: storing the decompressed data in the second memory space of the second physical memory, unmapping the virtual memory to which the first physical memory is mapped, releasing the first memory space of the first physical memory, and reading the decompressed data from the second memory space of the second physical memory.

In an embodiment, the reading the compressed data included in the at least one file system using the virtual memory may include: receiving a new read request after reading the decompressed data, map a new physical memory to the address space of the virtual memory, and decompress new compressed data included in mapping data mapped to the address space of the virtual memory.

In an embodiment, the reading the compressed data included in the at least one file system using the virtual memory may include: identifying a read request termination after reading the decompressed data, and releasing the at least one file system may include terminating the at least one file system based on identifying the read request termination, and releasing the address space of the virtual memory.

According to various example embodiments of the disclosure, the electronic device and data management method using the same may pre-allocate an address space of virtual memory in case of registering a file system, finally release the address space of the virtual memory in case of releasing the file system, and reuse the address space of the virtual memory while reading data based on a read request.

Therefore, the electronic device and data management method using the same of the disclosure do not need to allocate and release an address space of the virtual memory each time a read request occurs, thereby minimizing and/or reducing overhead due to allocation and release of the address space of the virtual memory and increasing process performance.

Effects achievable in example embodiments of the disclosure are not limited to the above-mentioned effects, but other effects not mentioned may be derived and understood by one of ordinary skill in the art to which the disclosure pertains, from the following description. In other words, unintended effects of the disclosure may also be derived by one of ordinary skill in the art from example embodiments of the disclosure.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example configuration of an electronic device according to various embodiments.

FIG. 2 is a block diagram illustrating an example configuration of an electronic device according to various embodiments.

FIG. 3 is a flowchart illustrating an example operation of an electronic device according to various embodiments.

FIG. 4 is a flowchart illustrating an example file system registration operation of an electronic device according to various embodiments.

FIG. 5 is a flowchart illustrating an example file read operation of an electronic device according to various embodiments.

FIG. 6 is a diagram illustrating an example physical memory and virtual memory according to various embodiments.

FIG. 7 is a flowchart illustrating an example file system release operation of an electronic device according to various embodiments.

FIG. 8 is a flowchart illustrating an example operation from address space allocation to address space release of virtual memory according to various embodiments.

FIG. 9 is a diagram illustrating an example usage cycle of virtual memory according to various embodiments.

FIG. 10 is a block diagram illustrating an example electronic device in a network environment according to various embodiments.

### DETAILED DESCRIPTION

Hereinafter, various example embodiments of the disclosure are described in greater detail with reference to the drawings. However, the disclosure may be implemented in various forms and is not limited to the example embodiments set forth herein. The same or similar reference denotations may be used to refer to the same or similar elements throughout the disclosure. Further, for clarity and brevity, no description may be made of well-known functions and configurations in the drawings and relevant descriptions.

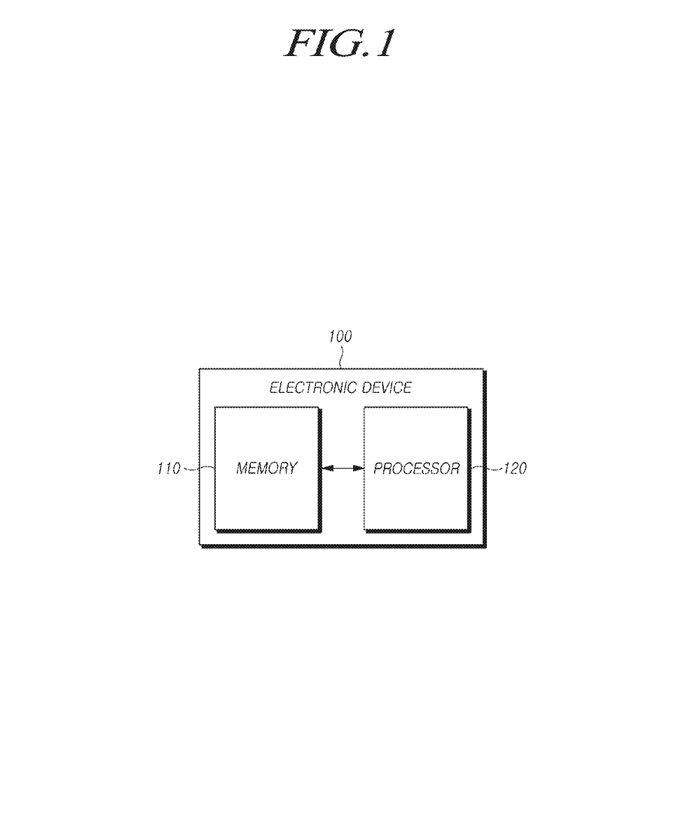

FIG. 1 is a block diagram illustrating an example configuration of an electronic device 100 according to various embodiments.

The electronic device 100 of the disclosure may be implemented as a display device capable of displaying an image. For example, the electronic device may include at least one of a TV, a computer, a smartphone, a tablet, a portable media player, a wearable device, a video wall, an electronic frame, or the like. The electronic device may be implemented as various types of devices such as an image processing device such as a settop box without a display, home appliances such as a refrigerator and a washer, an information processing device such as a computer body, or the like. Hereinafter, for convenience of description, it is assumed that the electronic device is implemented as a TV, but the electronic device of the present disclosure is not limited to this and may be applied to various electronic devices other than TVs such as settop boxes.

Referring to FIG. 1, an electronic device 100 according to an embodiment of the present disclosure may include a memory 110 and a processor (e.g., including processing circuitry) 120. The memory 110 may store data while power is supplied. The memory 110 may be a volatile storage component where data is lost in case that power is not supplied. For example, the memory 110 may include at least one of a buffer and random access memory (RAM).

The memory 110 of the disclosure may include physical memory and virtual memory. In case that a program is executed, predetermined data may be loaded into the memory 110 for each task of a process corresponding to the program. The memory 110 may load, from data or software stored in storage, data or software to be executed by the processor 120.

The memory 110 may include an area of general memory to which a general process is allocated and an area of kernel memory to which a kernel such as an operating system is allocated. The areas of each of the general memory and the kernel memory may be concentrated or distributed in any storage space of the memory 110. In an embodiment, the processor 120 may allocate a general process to a free portion of the kernel memory excluding a portion to which the operating system is allocated.

A process corresponding to a program may be allocated to the memory 110 and executed. The process may share a portion of the allocated memory with other processes. Therefore, even in case that one process is deleted, the shared memory may not be secured. Even in case that the execution of a program is terminated, a process allocated to the memory 110 may remain until it is deleted from the memory 110.

The memory 110 according to an embodiment of the present disclosure may be provided as an integrated unit or may be different memories, and is not limited to any one.

The processor 120 may include various processing circuitry and execute a program stored in storage. The processor 120 is implemented as at least one processor that loads at least a portion of a program from storage storing the program to the memory 110 and executes the program loaded in the memory 110. In case that a plurality of processors 120 of the present embodiment are implemented, these processors may be separated respectively or implemented as a plurality of modules in one integrated circuit (IC).

For example, the processor 120 may include at least one of a central processing unit (CPU), an application processor (AP), and/or a microprocessor. Thus, it will be understood that the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited /disclosed functions, e.g., in a distributed manner. At least one processor may execute program instructions to achieve or perform various functions. In case that the processor 120 executes a program stored in storage, predetermined data corresponding to each task of the corresponding process is loaded into the memory 110, so that the process may be in a state of occupying a specific area of the memory 110. The processor 120 may first load data about a process into the memory 110 and execute the process based on the data loaded in the memory 110. For example, the process may be a work unit executed based on data or an application loaded in the memory 110. In other words, one or more processes may be performed by the processor 120 processing data loaded in the memory 110 or executing an application loaded in the memory 110. For a process to be executed, data corresponding to the process may need to be loaded in the memory 110. For example, when data corresponding to a plurality of processes is loaded in the memory 110, multitasking may be performed by the processor 120 respectively executing the data for each process loaded in the memory 110.

According to an embodiment of the present disclosure, the processor 120 may execute a software program including one or more instructions stored in a storage medium readable by a machine such as the electronic device 100. For example, the processor 120 of the electronic device may call at least one instruction among one or more instructions stored from a storage medium and execute them. The one or more instructions may include a code generated by a compiler or a code executable by an interpreter. The machine-readable storage medium may be provided in the form of a non-transitory storage medium. Here, the 'non-transitory' storage medium is a tangible device and may not include a signal (e.g., electromagnetic waves), and this term does not distinguish whether data is stored in the storage medium semi-permanently or temporarily.

In an embodiment, a program executed by the processor 120 may be implemented as a computer program stored in a computer program product provided separately from the electronic device 100. In this case, the computer program product may include memory storing instructions corresponding to the computer program and a processor. Accordingly, the electronic device may download and execute a computer program stored in a separate computer program product to perform the operation of the processor 120.

In an embodiment, the program may be implemented as a computer-readable program stored on a recording medium. A program stored on the recording medium, e.g., data, may be directly accessed and executed by the processor 120, or may be downloaded to the electronic device and executed through a transmission medium implemented via a wired or wireless network to which computer systems are interconnected, thereby performing the operation.

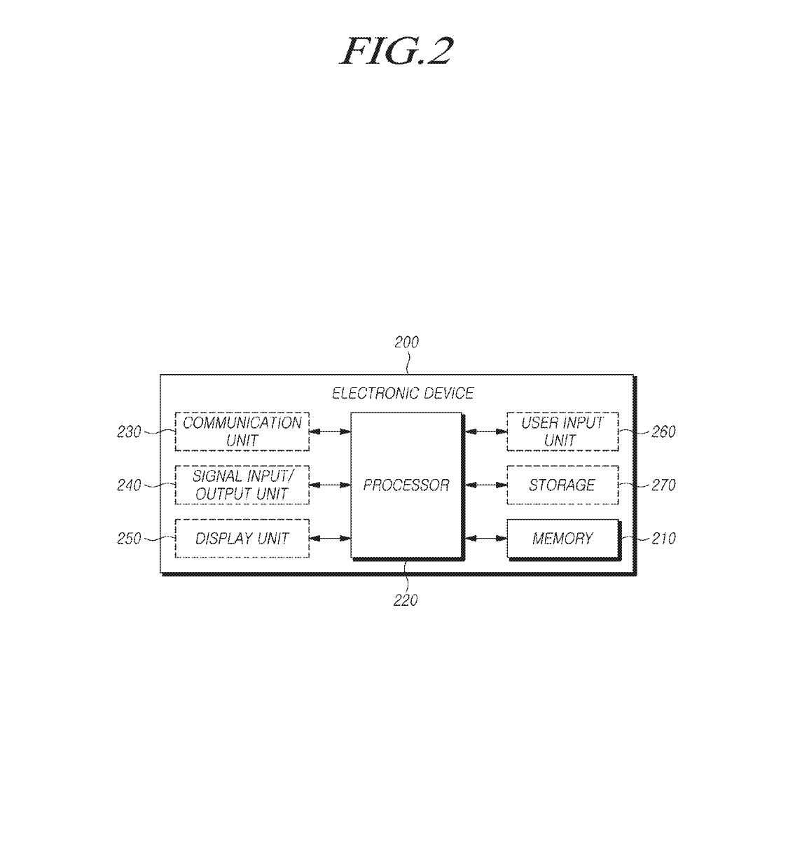

FIG. 2 is a block diagram illustrating an example configuration of an electronic device 200 according to various embodiments.

The electronic device 200 (e.g., the electronic device 100 of FIG. 1) may include at least one of a communication unit (e.g., including communication circuitry) 230, a signal input/output unit (e.g., including various circuitry) 240, a display unit (e.g., including a display) 250, a user input unit (e.g., including input circuitry) 260, and storage 270 in addition to the memory 210 (e.g., the memory 110 of FIG. 1) and the processor (e.g., including processing circuitry) 220 (e.g., the processor 120 of FIG. 1). The components included in the electronic device is not limited by the example, and may be configured by excluding or changing some components, or may be implemented by additionally including other components.

The communication unit 230 may include bi-directional communication circuitry including at least one or more of components such as communication modules and communication chips corresponding to various types of wired and wireless communication protocols. For example, the communication unit 230 may be implemented as a local area network (LAN) card wired to a router or gateway via Ethernet, a wireless communication module performing wireless communication with an access point (AP) according to a Wi-Fi method, or a wireless communication module performing one-to-one direct wireless communication such as Bluetooth.

The communication unit 230 may transmit/receive data packets with a server by communicating with the server on a network. As an embodiment, the communication unit 230 may be connected to an external device other than a server, and may receive video/audio data from the other external device or transmit video/audio data to the other external device. The communication unit 230 according to an embodiment of the present disclosure may receive or transmit related data to execute a process corresponding to a program stored in the storage 270.

The signal input/output unit 240 may include various circuitry and be wired to an external device such as a settop box or an optical media player, or an external display device or speaker in a 1:1 or 1:N (N is a natural number) manner, thereby receiving video/audio signals from the external device or outputting video/audio signals to the external device. For example, the signal input/output unit 240 may include a connector or port according to a preset transmission standard, such as a high-definition multimedia interface (HDMI) port, DisplayPort (DP), DVI port, Thunderbolt, or USB port. HDMI, DP, Thunderbolt, etc. may be connectors or ports that may simultaneously transmit video/audio signals. As another example, the signal input/output unit 240 may include a connector or port that transmits video/audio signals separately.

The display unit 250 may include a display panel capable of displaying an image on a screen. The display panel may be provided with a light-receiving structure such as a liquid crystal method or a self-luminous structure such as an OLED method. The display unit 250 may additionally include additional components according to the structure of the display panel. For example, the display unit 250 may include a liquid crystal display panel, a backlight unit supplying light, and a panel driving board driving liquid crystals of the liquid crystal display panel.

The storage 270 may store digitized data. The storage 270 may include non-volatile storage that may preserve data regardless of whether power is provided, and volatile memory where data to be processed by the processor 220 is loaded and data may not be preserved if power is not provided. However, in the electronic device according to the present disclosure, the storage 270 may refer to non-volatile storage. The storage 270 may include, e.g., at least one of flash memory, hard disk drive (HDD), solid state drive (SSD), or read only memory (ROM).

The user input unit 260 may include various circuitry and various types of input interface related circuitries provided to perform user input. The user input unit 260 may be implemented in various forms of configurations according to the type of the electronic device 200. For example, the user input unit 260 may include at least one of a mechanical or electronic button unit of the electronic device 200, a remote controller separated from the electronic device, a touchpad, or a touch screen installed in the display unit 250.

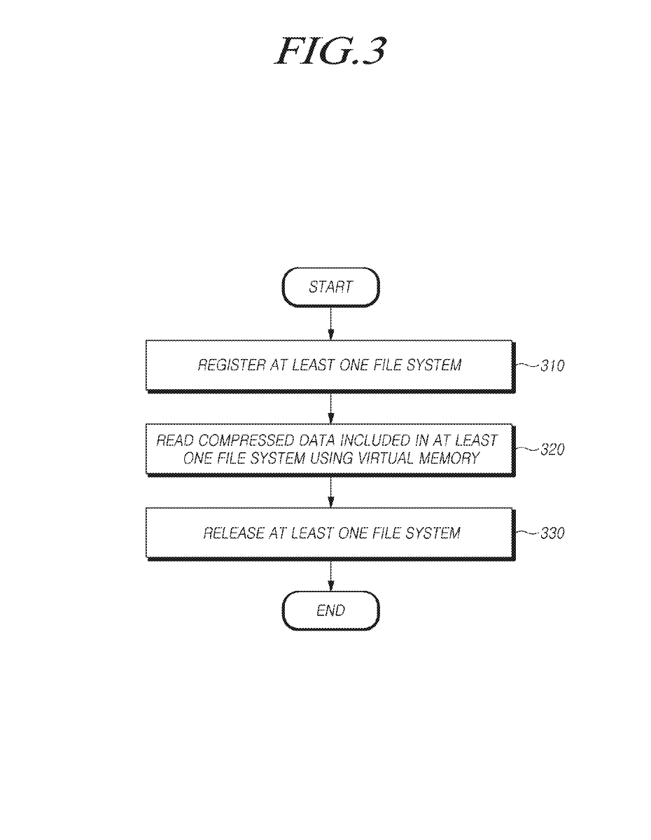

FIG. 3 is a flowchart illustrating an example operation of the electronic device 100 according to various embodiments.

Referring to FIG. 3, the electronic device 100 of the disclosure may register at least one file system (operation 310), read compressed data included in the at least one file system using virtual memory according to an occurrence of a read request (operation 320), and release the at least one file system (operation 330).

According to an example, in operation 310, the electronic device 100 may register at least one file system. For example, the electronic device 100 may recognize the at least one file system at a first time point. The electronic device 100 may initialize the at least one file system. The electronic device 100 may allocate an address space of the virtual memory. In other words, the virtual memory may have an address space allocated in case that the at least one file system is registered. The electronic device 100 may register the at least one file system in a main system.

According to an example, in operation 320, the electronic device 100 may read compressed data included in the at least one file system using virtual memory according to an occurrence of a read request. For example, the electronic device 100 may decompress the compressed data based on occurrence of the read request. For example, the electronic device 100 may read decompressed data that is decompressed from the compressed data.

The electronic device 100 may allocate a first memory space of first physical memory storing the compressed data. The electronic device 100 may allocate a second memory space of second physical memory storing decompressed data. The electronic device 100 may load the compressed data from a disk including the at least one file system. The virtual memory may be used for decompression of compressed data based on a read request. For example, the electronic device 100 may map the first physical memory to the address space of the virtual memory. The electronic device 100 may generate the decompressed data by decompressing the compressed data from the address space of the virtual memory.

The electronic device 100 may store the decompressed data in the second memory space of the second physical memory. The electronic device 100 may unmap the virtual memory to which the first physical memory is mapped. The electronic device 100 may release the first memory space of the first physical memory. The electronic device 100 may read the decompressed data from the second memory space of the second physical memory.

According to an example, in operation 330, the electronic device 100 may release the at least one file system. For example, the electronic device 100 may terminate the at least one file system at a second time point. The electronic device 100 may release the address space of the virtual memory. In other words, the virtual memory may have the address space released in case that the at least one file system is released. The electronic device 100 may clean up the virtual memory and remove the at least one file system from a main system.

As such, the electronic device 100 of the disclosure may pre-allocate an address space of virtual memory in case of registering a file system, finally release the address space of virtual memory in case of releasing the file system, and reuse the address space of virtual memory while reading data based on a read request.

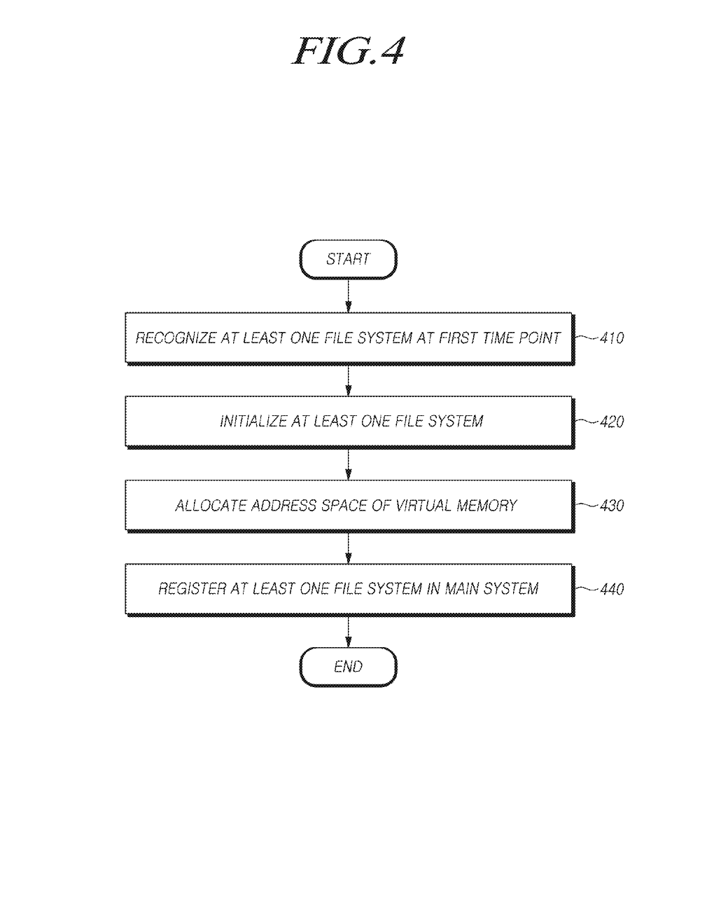

FIG. 4 is a flowchart illustrating an example file system registration operation of the electronic device 100 according to various embodiments.

Referring to FIG. 4, the electronic device 100 may recognize the at least one file system at a first time point (operation 410), initialize the at least one file system (operation 420), allocate the address space of the virtual memory (operation 430), and register the at least one file system in a main system (operation 440).

According to an example, in operation 410, the electronic device 100 may recognize the at least one file system at a first time point. The first time point may be at least one of a time point at which the main system is booted and a time point at which a disk including the at least one file system is mounted. For example, the electronic device 100 may recognize the at least one file system at the time point at which the main system is booted. For example, the electronic device 100 may recognize the at least one file system at the time point at which the disk including the at least one file system is mounted.

According to an example, in operation 420, the electronic device 100 may initialize the at least one file system. In case of initializing a file system, the electronic device 100 may generate metadata of the file system and generate a data structure of the file system. For example, the electronic device 100 may generate metadata of at least one file system including compressed data. The metadata may include at least one of the type, size, available space, and allocated space of the file system. For example, the electronic device 100 may generate a data structure of at least one file system. The data structure may include at least one of a block bitmap, an index, and a tree structure for storing data in a file or directory by the electronic device 100.

According to an example, in operation 430, the electronic device 100 may allocate the address space of the virtual memory. The address space of virtual memory may provide a virtual and continuous memory space to a processor rather than physical memory in case that a process is performed. For example, the processor may be allocated an address space to store data and instructions necessary for performing a process. For example, the electronic device 100 may identify the size of virtual memory required by a file system. For example, the electronic device 100 may allocate an address space of the virtual memory and reserve the address space of the virtual memory for at least one file system.

According to an example, in operation 440, the electronic device 100 may register the at least one file system in a main system. For example, the electronic device 100 may register at least one file system to a system list of the main system. The main system may access compressed data in a disk via the at least one file system registered in the system list.

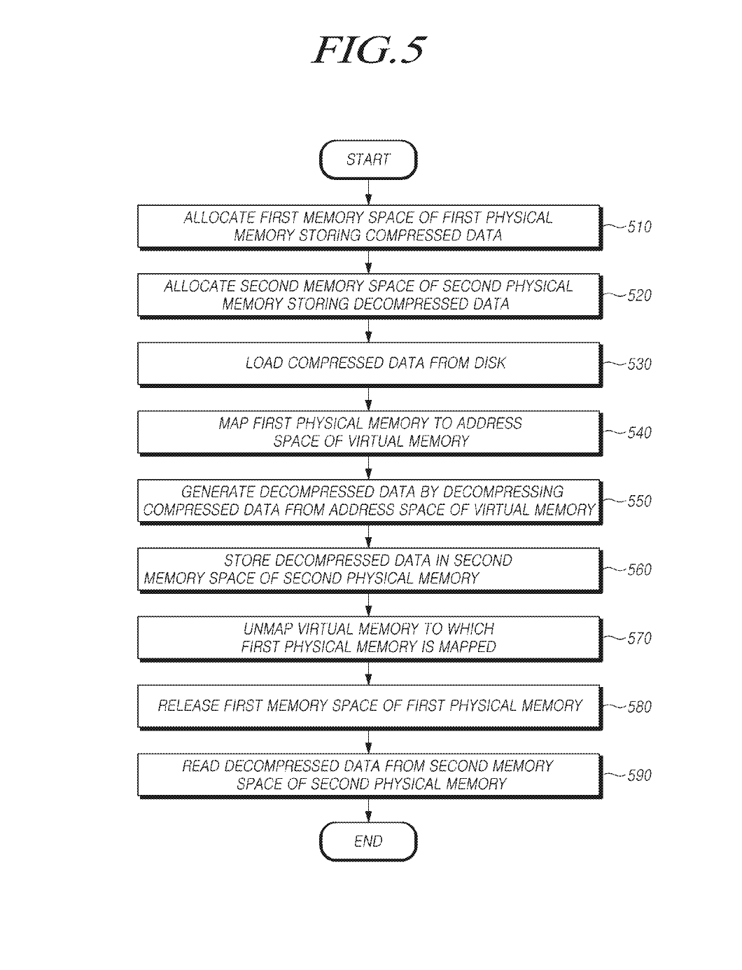

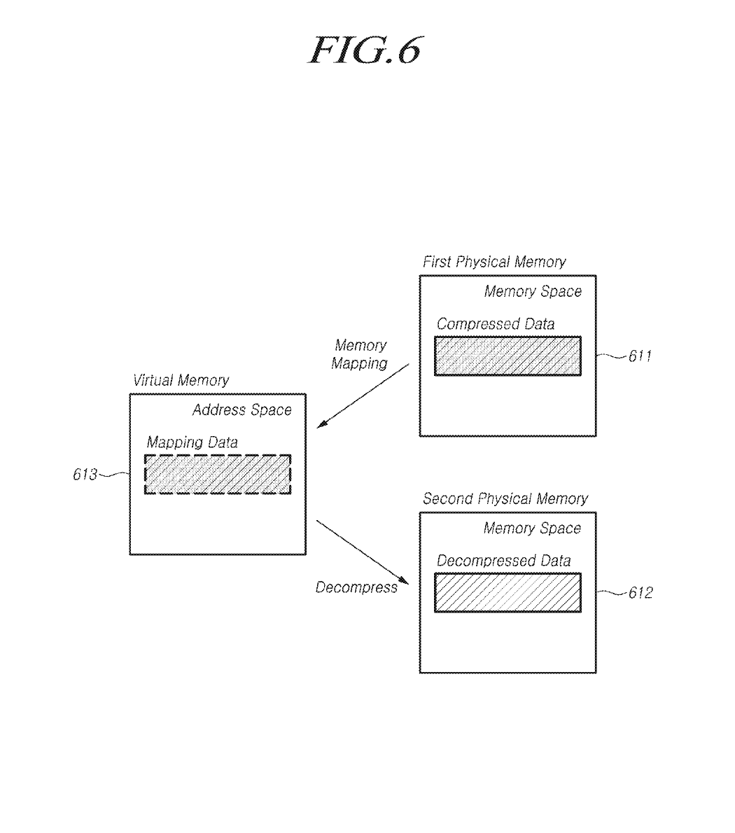

FIG. 5 is a flowchart illustrating an example file read operation of the electronic device 100 according to various embodiments, and FIG. 6 is a diagram illustrating an example physical memory and virtual memory according to various embodiments.

Referring to FIGS. 5 and 6, the electronic device 100 may allocate a first memory space of first physical memory storing compressed data (operation 510), allocate a second memory space of second physical memory storing decompressed data (operation 520), load the compressed data from a disk including the at least one file system (operation 530), map the first physical memory to the address space of the virtual memory (operation 540), and generate the decompressed data by decompressing the compressed data from the address space of the virtual memory (operation 550). Further, the electronic device 100 may store the decompressed data in the second memory space of the second physical memory (operation 560), unmap the virtual memory to which the first physical memory is mapped (operation 570), release the first memory space of the first physical memory (operation 580), and read the decompressed data from the second memory space of the second physical memory (operation 590).

According to an example, in operation 510, the electronic device 100 may allocate a first memory space of first physical memory storing the compressed data. For example, the electronic device 100 may receive a read request and allocate a first memory space to first physical memory based on at least one file system. The first memory space allocated to the first physical memory may store compressed data of at least one file system.

According to an example, in operation 520, the electronic device 100 may allocate a second memory space of second physical memory storing decompressed data. For example, the electronic device 100 may receive a read request and allocate a second memory space to second physical memory based on at least one file system. The second memory space allocated to the second physical memory may store decompressed data that is decompressed from the compressed data.

According to an example, in operation 530, the electronic device 100 may load the compressed data from a disk including the at least one file system. For example, the disk may include at least one of a hard disk drive (HDD), a solid state drive (SSD), a universal serial bus (USB) flash drive, a secure digital (SD) card, and network attached storage. The electronic device 100 may load compressed data compressed with a predetermined compression algorithm from the at least one file system.

According to an example, in operation 540, the electronic device 100 may map the first physical memory to the address space of the virtual memory. For example, the electronic device 100 may map the first memory space of the first physical memory 611 storing compressed data to the address space of the virtual memory 613. As illustrated in FIG. 6, as the first memory space of the first physical memory 611 is mapped to the address space of the virtual memory 613, the address space of the virtual memory 613 may include mapping data. As such, as the first memory space of the first physical memory 611 is mapped to the address space of the virtual memory 613, the processor may access compressed data via the address space of the virtual memory 613 without needing to know the location of the first physical memory 611.

According to an example, in operation 550, the electronic device 100 may generate the decompressed data by decompressing the compressed data from the address space of the virtual memory 613. For example, the electronic device 100 may access the compressed data using the mapping data of the address space of the virtual memory 613. The electronic device 100 may decompress the compressed data using a predetermined decompression algorithm. The electronic device 100 may generate decompressed data based on decompression of the compressed data.

According to an example, in operation 560, the electronic device 100 may store the decompressed data in the second memory space of the second physical memory 612. For example, as illustrated in FIG. 6, the decompressed data may be stored in the second memory space of the second physical memory 612. The decompressed data may be restored original data.

According to an example, in operation 570, the electronic device 100 may unmap the virtual memory to which the first physical memory is mapped. For example, the electronic device 100 may unmap the first physical memory from the virtual memory after decompressing compressed data based on mapping data. For example, the electronic device 100 may unmap by removing a connection between the address space of the virtual memory and the memory space of the first physical memory in a page table.

According to an example, in operation 580, the electronic device 100 may release the first memory space of the first physical memory. For example, the electronic device 100 may release the first memory space from the first physical memory after decompressing compressed data. For example, the electronic device 100 may return resources of the first memory space from the first physical memory. For example, the electronic device 100 may reuse the first memory space as a new memory space in the first physical memory.

According to an example, in operation 590, the electronic device 100 may read the decompressed data from the second memory space of the second physical memory. For example, the electronic device 100 may read the decompressed data by accessing the decompressed data through the second memory space. For example, the electronic device 100 may perform at least one of reading the decompressed data, using the decompressed data for at least one process, and using the decompressed data for at least one operation.

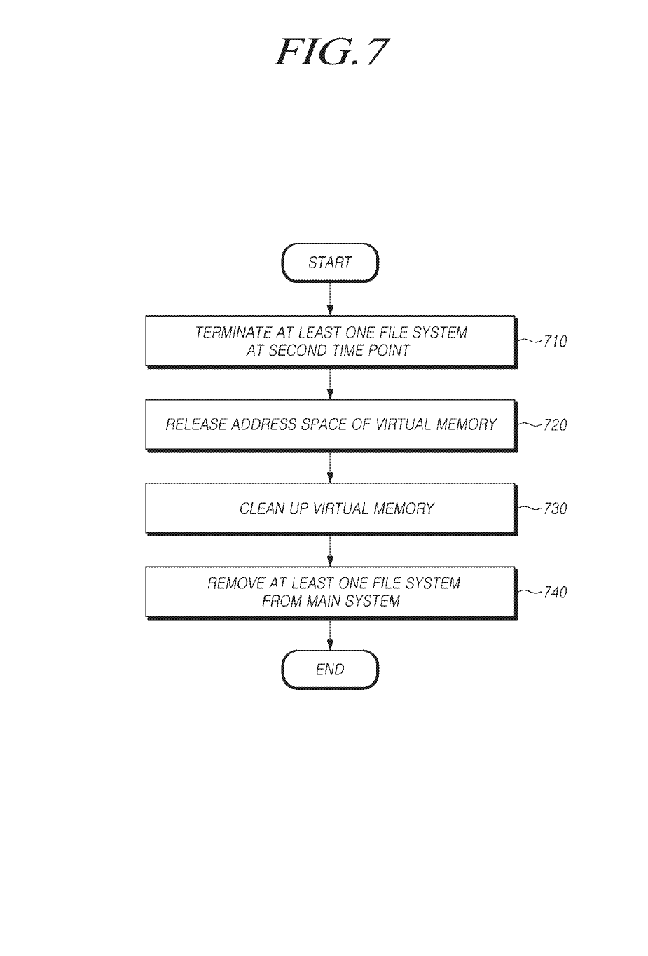

FIG. 7 is a flowchart illustrating an example file system release operation of the electronic device 100 according to various embodiments.

Referring to FIG. 7, the electronic device 100 may terminate the at least one file system at a second time point (operation 710), release the address space of the virtual memory (operation 720), clean up the virtual memory (operation 730), and remove the at least one file system from a main system (operation 740).

According to an example, in operation 710, the electronic device 100 may terminate the at least one file system at a second time point. The second time point may be at least one of a time point at which a process of the main system is terminated and a time point at which a disk including the at least one file system is unmounted. For example, the electronic device 100 may terminate the at least one file system at the time point at which a process of the main system is terminated. For example, the electronic device 100 may terminate the at least one file system at the time point at which the disk including the at least one file system is unmounted.

According to an example, in operation 720, the electronic device 100 may release the address space of the virtual memory. For example, the electronic device 100 may release the address space of virtual memory reserved for the at least one file system. For example, the electronic device 100 may provide memory resources allocated to the address space to the main system by deactivating the address space of the virtual memory.

According to an example, in operation 730, the electronic device 100 may clean up the virtual memory. For example, the electronic device 100 may delete a usage record of virtual memory used by at least one file system. For example, the electronic device 100 may delete information of the virtual memory from a data structure including a memory map, a page table, or the like. For example, the electronic device 100 may deactivate the virtual memory by cleaning up the virtual memory.

According to an example, in operation 740, the electronic device 100 may remove the at least one file system from a main system. For example, the electronic device 100 may remove the data structure of the file system from the main system. For example, the electronic device 100 may remove registration information of the file system from the main system.

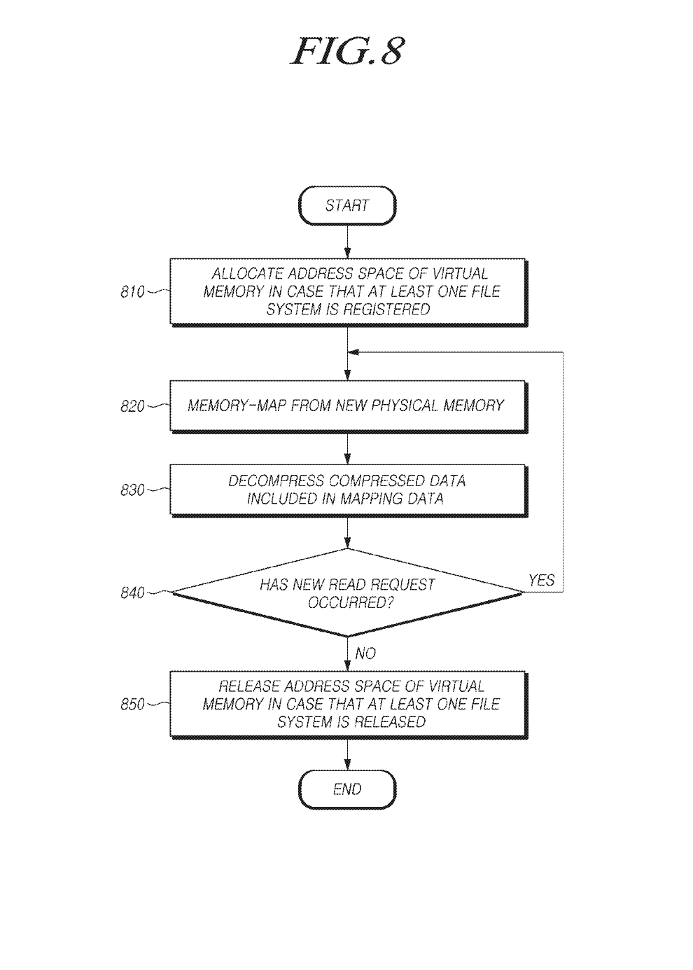

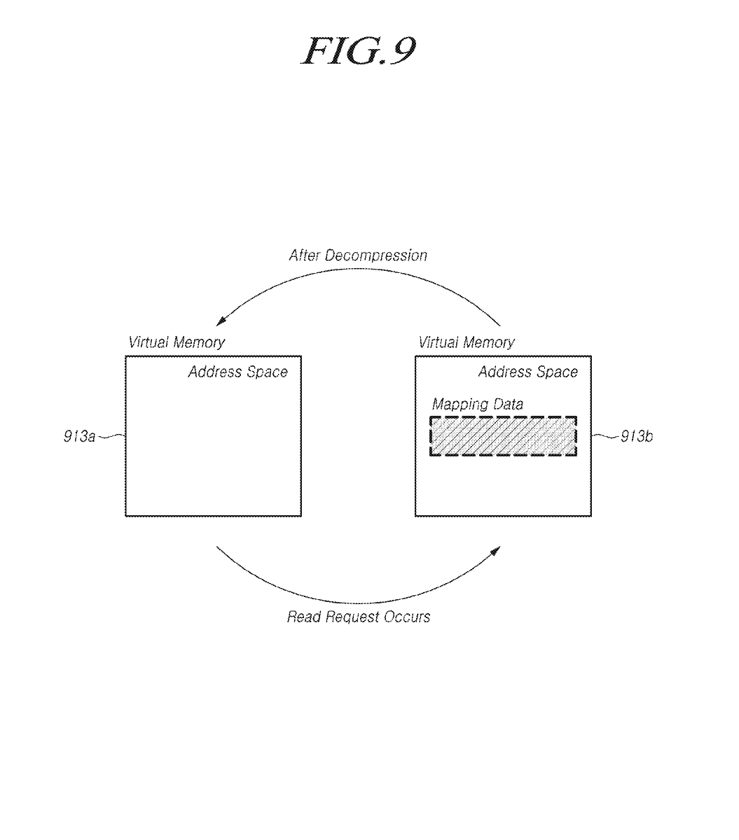

FIG. 8 is a flowchart illustrating an example operation from address space allocation to address space release of a virtual memory according to various embodiments, and FIG. 9 is a diagram illustrating an example usage cycle of a virtual memory according to various embodiments.

Referring to FIGS. 8 and 9, the electronic device 100 may allocate an address space of virtual memory in case that at least one file system is registered (operation 810). The virtual memory may be memory-mapped from a new physical memory (operation 820). Compressed data included in mapping data of the virtual memory may be decompressed (830). The electronic device 100 may determine whether a new read request occurs (operation 840). In case that a new read request occurs, the virtual memory may be memory-mapped from a new physical memory again (operation 820). In case that a new read request does not occur, the electronic device 100 may release the address space of the virtual memory in case that at least one file system is released (operation 850).

As illustrated in FIG. 9, the virtual memory 913a may have an address space allocated in case that at least one file system is registered. In other words, the virtual memory 913a may have an address space allocated in advance before a new read request occurs. The virtual memory 913b may be memory-mapped from a physical memory according to an occurrence of a read request. The electronic device 100 may access compressed data included in the physical memory based on mapping data generated according to memory mapping. The electronic device 100 may generate decompressed data by decompressing compressed data included in the mapping data.

After the compressed data is decompressed, the electronic device 100 may determine whether a new read request occurs. For example, in case that a new read request occurs, the electronic device 100 may reuse the address space of the virtual memory 913a to map the virtual memory 913a from a new physical memory. The electronic device 100 may receive a new read request, map a new physical memory to the address space of the virtual memory 913b, and decompress new compressed data included in mapping data mapped to the address space of the virtual memory 913b. As another example, in case that a new read request does not occur, the electronic device 100 may release the address space of the virtual memory 913b. After reading the decompressed data, identify a read request termination, terminate the at least one file system, and release the address space of the virtual memory 913b.

As such, the electronic device 100 of the disclosure may pre-allocate an address space of virtual memory in case of registering a file system, finally release the address space of virtual memory in case of releasing the file system, and reuse the address space of virtual memory while reading data based on a read request.

Therefore, the electronic device 100 of the disclosure does not need to allocate and release the address space of virtual memory each time a read request occurs, thereby minimizing/reducing overhead due to allocation and release of the address space of virtual memory and increasing process performance.

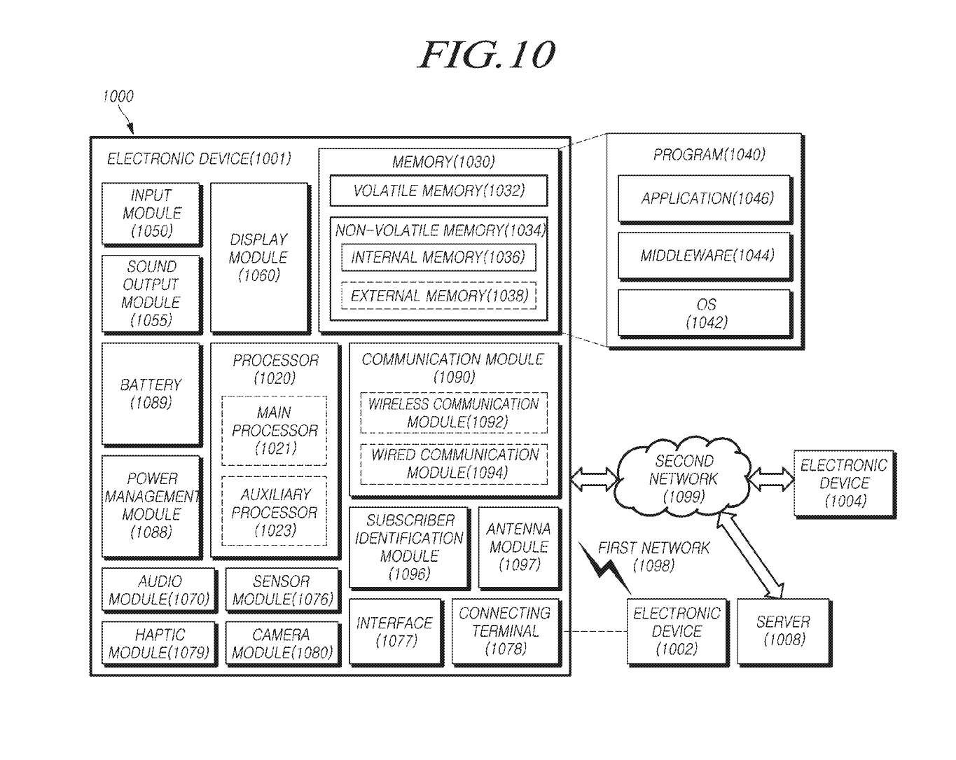

FIG. 10 is a block diagram illustrating an example electronic device 1001 in a network environment 1000 according to various embodiments.

Referring to FIG. 10, the electronic device 1001 in the network environment 1000 may communicate with an electronic device 1002 via a first network 1098 (e.g., a short-range wireless communication network), or an electronic device 1004 or a server 1008 via a second network 1099 (e.g., a long-range wireless communication network). According to an embodiment, the electronic device 1001 may communicate with the electronic device 1004 via the server 1008. According to an embodiment, the electronic device 1001 may include a processor 1020, memory 1030, an input module 1050, a sound output module 1055, a display module 1060, an audio module 1070, a sensor module 1076, an interface 1077, a connecting terminal 1078, a haptic module 1079, a camera module 1080, a power management module 1088, a battery 1089, a communication module 1090, a subscriber identification module (SIM) 1096, or an antenna module 1097. In an embodiment, at least one (e.g., the connecting terminal 1078) of the components may be omitted from the electronic device 1001, or one or more other components may be added in the electronic device 1001. According to an embodiment, some (e.g., the sensor module 1076, the camera module 1080, or the antenna module 1097) of the components may be integrated into a single component (e.g., the display module 1060).

The processor 1020 may execute, for example, software (e.g., a program 1040) to control at least one other component (e.g., a hardware or software component) of the electronic device 1001 coupled with the processor 1020, and may perform various data processing or computation. According to an embodiment, as at least part of the data processing or computation, the processor 1020 may store a command or data received from another component (e.g., the sensor module 1076 or the communication module 1090) in volatile memory 1032, process the command or the data stored in the volatile memory 1032, and store resulting data in non-volatile memory 1034. According to an embodiment, the processor 1020 may include a main processor 1021 (e.g., a central processing unit (CPU) or an application processor (AP)), or an auxiliary processor 1023 (e.g., a graphics processing unit (GPU), a neural processing unit (NPU), an image signal processor (ISP), a sensor hub processor, or a communication processor (CP)) that is operable independently from, or in conjunction with, the main processor 1021. For example, when the electronic device 1001 includes the main processor 1021 and the auxiliary processor 1023, the auxiliary processor 1023 may be configured to use lower power than the main processor 1021 or to be specified for a designated function. The auxiliary processor 1023 may be implemented as separate from, or as part of the main processor 1021. Thus, the processor 1020 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited /disclosed functions, e.g., in a distributed manner. At least one processor may execute program instructions to achieve or perform various functions.

The auxiliary processor 1023 may control at least some of functions or states related to at least one component (e.g., the display module 1060, the sensor module 1076, or the communication module 1090) among the components of the electronic device 1001, instead of the main processor 1021 while the main processor 1021 is in an inactive (e.g., sleep) state, or together with the main processor 1021 while the main processor 1021 is in an active state (e.g., executing an application). According to an embodiment, the auxiliary processor 1023 (e.g., an image signal processor or a communication processor) may be implemented as part of another component (e.g., the camera module 1080 or the communication module 1090) functionally related to the auxiliary processor 1023. According to an embodiment, the auxiliary processor 1023 (e.g., the neural processing unit) may include a hardware structure specified for artificial intelligence model processing. The artificial intelligence model may be generated via machine learning. Such learning may be performed, e.g., by the electronic device 1001 where the artificial intelligence is performed or via a separate server (e.g., the server 1008). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1030 may store various data used by at least one component (e.g., the processor 1020 or the sensor module 1076) of the electronic device 1001. The various data may include, for example, software (e.g., the program 1040) and input data or output data for a command related thereto. The memory 1030 may include the volatile memory 1032 or the non-volatile memory 1034.

The program 1040 may be stored in the memory 1030 as software, and may include, for example, an operating system (OS) 1042, middleware 1044, or an application 1046.

The input module 1050 may receive a command or data to be used by other component (e.g., the processor 1020) of the electronic device 1001, from the outside (e.g., a user) of the electronic device 1001. The input module 1050 may include, for example, a microphone, a mouse, a keyboard, keys (e.g., buttons), or a digital pen (e.g., a stylus pen).

The sound output module 1055 may output sound signals to the outside of the electronic device 1001. The sound output module 1055 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1060 may visually provide information to the outside (e.g., a user) of the electronic device 1001. The display module 1060 may include, for example, a display, a hologram device, or a projector and control circuitry to control a corresponding one of the display, hologram device, and projector. According to an embodiment, the display module 1060 may include a touch sensor configured to detect a touch, or a pressure sensor configured to measure the intensity of a force generated by the touch.

The audio module 1070 may convert a sound into an electrical signal and vice versa. According to an embodiment, the audio module 1070 may obtain the sound via the input module 1050, or output the sound via the sound output module 1055 or a headphone of an external electronic device (e.g., an electronic device 1002) directly (e.g., wiredly) or wirelessly coupled with the electronic device 1001.

The sensor module 1076 may detect an operational state (e.g., power or temperature) of the electronic device 1001 or an environmental state (e.g., a state of a user) external to the electronic device 1001, and then generate an electrical signal or data value corresponding to the detected state. According to an embodiment, the sensor module 1076 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 1077 may support one or more specified protocols to be used for the electronic device 1001 to be coupled with the external electronic device (e.g., the electronic device 1002) directly (e.g., wiredly) or wirelessly. According to an embodiment, the interface 1077 may include, for example, a high definition multimedia interface (HDMI), a universal serial bus (USB) interface, a secure digital (SD) card interface, or an audio interface.

A connecting terminal 1078 may include a connector via which the electronic device 1001 may be physically connected with the external electronic device (e.g., the electronic device 1002). According to an embodiment, the connecting terminal 1078 may include, for example, a HDMI connector, a USB connector, a SD card connector, or an audio connector (e.g., a headphone connector).

The haptic module 1079 may convert an electrical signal into a mechanical stimulus (e.g., a vibration or motion) or electrical stimulus which may be recognized by a user via his tactile sensation or kinesthetic sensation. According to an embodiment, the haptic module 1079 may include, for example, a motor, a piezoelectric element, or an electric stimulator.

The camera module 1080 may capture a still image or moving images. According to an embodiment, the camera module 1080 may include one or more lenses, image sensors, image signal processors, or flashes.

The power management module 1088 may manage power supplied to the electronic device 1001. According to an embodiment, the power management module 1088 may be implemented as at least part of, for example, a power management integrated circuit (PMIC).

The battery 1089 may supply power to at least one component of the electronic device 1001. According to an embodiment, the battery 1089 may include, for example, a primary cell which is not rechargeable, a secondary cell which is rechargeable, or a fuel cell.

The communication module 1090 may support establishing a direct (e.g., wired) communication channel or a wireless communication channel between the electronic device 1001 and the external electronic device (e.g., the electronic device 1002, the electronic device 1004, or the server 1008) and performing communication via the established communication channel. The communication module 1090 may include one or more communication processors that are operable independently from the processor 1020 (e.g., the application processor (AP)) and supports a direct (e.g., wired) communication or a wireless communication. According to an embodiment, the communication module 1090 may include a communication module 1092 (e.g., a cellular communication module, a short-range communication module, or a global navigation satellite system (GNSS) communication module) or a wired communication module 1094 (e.g., a local area network (LAN) communication module or a power line communication (PLC) module). A corresponding one of these communication modules may communicate with the external electronic device 1004 via a first network 1098 (e.g., a short-range communication network, such as Bluetooth^{TM}, wireless-fidelity (Wi-Fi) direct, or infrared data association (IrDA)) or a second network 1099 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The communication module 1092 may identify or authenticate the electronic device 1001 in a communication network, such as the first network 1098 or the second network 1099, using subscriber information (e.g., international mobile subscriber identity (IMSI)) stored in the subscriber identification module 1096.

The communication module 1092 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The communication module 1092 may support a high-frequency band (e.g., the mmWave band) to achieve, e.g., a high data transmission rate. The communication module 1092 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The communication module 1092 may support various requirements specified in the electronic device 1001, an external electronic device (e.g., the electronic device 1004), or a network system (e.g., the second network 1099). According to an embodiment, the communication module 1092 may support a peak data rate (e.g., 20Gbps or more) for implementing eMBB, loss coverage (e.g., 164dB or less) for implementing mMTC, or U-plane latency (e.g., 0.5ms or less for each of downlink (DL) and uplink (UL), or a round trip of 1ms or less) for implementing URLLC.

The antenna module 1097 may transmit or receive a signal or power to or from the outside (e.g., the external electronic device). According to an embodiment, the antenna module 1097 may include one antenna including a radiator formed of a conductor or conductive pattern formed on a substrate (e.g., a printed circuit board (PCB)). According to an embodiment, the antenna module 1097 may include a plurality of antennas (e.g., an antenna array). In this case, at least one antenna appropriate for a communication scheme used in a communication network, such as the first network 1098 or the second network 1099, may be selected from the plurality of antennas by, e.g., the communication module 1090. The signal or the power may then be transmitted or received between the communication module 1090 and the external electronic device via the selected at least one antenna. According to an embodiment, other parts (e.g., radio frequency integrated circuit (RFIC)) than the radiator may be further formed as part of the antenna module 1097.

According to various embodiments, the antenna module 1097 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, an electronic device (e.g., 1001) may pre-allocate an address space of virtual memory in case of registering a file system, finally release the address space of virtual memory in case of releasing the file system, and reuse the address space of virtual memory while reading data based on a read request.

Therefore, the electronic device (e.g., 1001) of the disclosure does not need to allocate and release the address space of virtual memory each time a read request occurs, thereby minimizing/reducing overhead due to allocation and release of the address space of virtual memory and increasing process performance.

Since this has been described above, a duplicate description may not be repeated here.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as "A or B," "at least one of A and B," “at least one of A or B,” "A, B, or C," "at least one of A, B, and C," and “at least one of A, B, or C,” may include all possible combinations of the items enumerated together in a corresponding one of the phrases. As used herein, such terms as "1st" and "2nd," or “first” and "second" may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” "coupled to," "connected with," or “connected to” another element (e.g., a second element), the element may be coupled with the other element directly (e.g., wiredly), wirelessly, or via a third element.

As used herein, the term "module" may include a unit implemented in hardware, software, or firmware, or any combination thereof, and may interchangeably be used with other terms, for example, "logic," "logic block," "part," or "circuitry". A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1040) including one or more instructions that are stored in a storage medium (e.g., internal memory 1036 or external memory 1038) that is readable by a machine (e.g., the electronic device 1001). For example, a processor (e.g., the processor 1020) of the machine (e.g., the electronic device 1001) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the "non-transitory" storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store^{TM}), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device for reading a compressed file, comprising:
memory storing at least one instruction; and
at least one processor, comprising processing circuitry, individually and/or collectively, configured to execute the at least one instruction, and to cause the electronic device to:
register at least one file system;
read compressed data included in the at least one file system using virtual memory based on a read request occurring; and
release the at least one file system, wherein the virtual memory includes an address space allocated based on the at least one file system being registered, is configured for decompression of the compressed data based on the read request, and includes the address space released based on the at least one file system being released.

2. The electronic device of claim 1, wherein the virtual memory, after being used for decompression of the compressed data based on the read request, is configured to reuse the address space for decompression of new compressed data by being memory-mapped from new physical memory based on a new read request occurring.

3. The electronic device of claim 1, wherein at least one processor, individually and/or collectively, is configured to cause the electronic device to:
recognize the at least one file system at a first time point;
initialize the at least one file system;
allocate the address space of the virtual memory; and
register the at least one file system in a main system.

4. The electronic device of claim 3, wherein the first time point includes at least one of a time point at which the main system is booted and a time point at which a disk including the at least one file system is mounted.

5. The electronic device of claim 1, wherein at least one processor, individually and/or collectively, is configured to cause the electronic device to:
terminate the at least one file system at a second time point;
release the address space of the virtual memory;
clean up the virtual memory; and
remove the at least one file system from a main system.

6. The electronic device of claim 5, wherein the second time point includes at least one of a time point at which a process of the main system is terminated and a time point at which a disk including the at least one file system is unmounted.

7. The electronic device of claim 1, wherein at least one processor, individually and/or collectively, is configured to cause the electronic device to:
allocate a first memory space of first physical memory storing the compressed data;
allocate a second memory space of second physical memory storing decompressed data;
load the compressed data from a disk including the at least one file system;
map the first physical memory to the address space of the virtual memory; and
generate the decompressed data by decompressing the compressed data from the address space of the virtual memory.

8. The electronic device of claim 7, wherein at least one processor, individually and/or collectively, is configured to cause the electronic device to:
store the decompressed data in the second memory space of the second physical memory;
unmap the virtual memory to which the first physical memory is mapped;
release the first memory space of the first physical memory; and
read the decompressed data from the second memory space of the second physical memory.

9. The electronic device of claim 8, wherein at least one processor, individually and/or collectively, is configured to cause the electronic device to:
receive a new read request after reading the decompressed data;
map a new physical memory to the address space of the virtual memory; and
decompress new compressed data included in mapping data mapped to the address space of the virtual memory.

10. The electronic device of claim 8, wherein at least one processor, individually and/or collectively, is configured to cause the electronic device to:
identify a read request termination after reading the decompressed data;
terminate the at least one file system; and
release the address space of the virtual memory.

11. A method for managing data using an electronic device, the method comprising:
registering at least one file system;
reading compressed data included in the at least one file system using virtual memory based on a read request occurring; and
releasing the at least one file system, wherein the virtual memory:
has an address space allocated based on the electronic device registering the at least one file system;
is used for decompression of the compressed data based on the read request; and
has the address space released based on the electronic device releasing the at least one file system.

12. The method of claim 11, wherein the virtual memory, after being used for decompression of the compressed data based on the read request, is configured to reuse the address space for decompression of new compressed data by being memory-mapped from new physical memory based on a new read request occurring.

13. The method of claim 11, wherein the registering the at least one file system comprises:
recognizing the at least one file system at a first time point;
initializing the at least one file system;
allocating the address space of the virtual memory; and
registering the at least one file system in a main system.

14. The method of claim 13, wherein the first time point includes at least one of a time point at which the main system is booted and a time point at which a disk including the at least one file system is mounted.

15. The method of claim 11, wherein the releasing the at least one file system comprises:
terminating the at least one file system at a second time point;
releasing the address space of the virtual memory;
cleaning up the virtual memory; and
removing the at least one file system from a main system.

16. The method of claim 15, wherein the second time point includes at least one of a time point at which a process of the main system is terminated and a time point at which a disk including the at least one file system is unmounted.

17. The method of claim 11, wherein the reading compressed data included in the at least one file system using virtual memory comprises:
allocating a first memory space of first physical memory storing the compressed data;
allocating a second memory space of second physical memory storing decompressed data;
loading the compressed data from a disk including the at least one file system;
mapping the first physical memory to the address space of the virtual memory; and
generating the decompressed data by decompressing the compressed data from the address space of the virtual memory.

18. The method of claim 17, wherein the reading compressed data included in the at least one file system using virtual memory further comprises:
storing the decompressed data in the second memory space of the second physical memory;
unmapping the virtual memory to which the first physical memory is mapped;
releasing the first memory space of the first physical memory; and
reading the decompressed data from the second memory space of the second physical memory.

19. The method of claim 18, wherein the reading compressed data included in the at least one file system using virtual memory further comprises:
receiving a new read request after reading the decompressed data;
mapping a new physical memory to the address space of the virtual memory; and
decompressing new compressed data included in mapping data mapped to the address space of the virtual memory.

20. The method of claim 18, wherein the reading compressed data included in the at least one file system using virtual memory further comprises identifying a read request termination after reading the decompressed data, and
wherein the releasing the at least one file system comprises terminating the at least one file system based on identifying the read request termination.
